(19) United States
(12) Patent Application Publication
(10) Pub. No.: US 2012/0098228 A1
(43) Pub. Date: Apr. 26, 2012

(54) STAMPED ARM CONTROL

(75) Inventors: Bryan D. Wilson, Warren, MI (US); Kennet A. Mangus, Auburn Hills, MI (US); Chris Loo, Toronto (CA); Frank Tomassini, Bolton (CA)

(73) Assignees: MULTIMATIC INC., Markham (CA); GM GLOBAL TECHNOLOGY OPERATIONS, INC., Detroit, MI (US)

(21) Appl. No.: 12/908,209

(22) Filed: Oct. 20, 2010

(51) Int. Cl. B60G 7/00; B60G 3/06

(52) U.S. Cl. 280/124.134

(57) ABSTRACT

A control arm includes a first clamshell half and a second clamshell half, a ball joint housing, and a paddle portion. The paddle portion is formed as a single piece with the ball joint housing, has a first side and a second side, and is disposed between the first clamshell half and the second clamshell half. A first weld connection may join the first clamshell half to the first side of the paddle portion, and a second weld connection may join the second clamshell half to the second side of the paddle portion. Attachment of the first clamshell half to the first side of the paddle portion and attachment of the second clamshell half to the second side of the paddle portion may be characterized by the absence of a rivet and a bolt.

### TECHNICAL FIELD

This disclosure relates to control arms for vehicular suspension systems.

### BACKGROUND

On most vehicles, the suspension system supports the vehicle weight, absorbs and dampens shock, and helps maintain contact between the tires and the road. Among other things, the suspension system allows relative movement between the tires and the chassis. Suspension systems also absorb energy and dissipate energy.

Some suspension systems, including wishbone systems or MacPherson strut systems, incorporate one or more control arms at the suspension corners. The control arms mount to the chassis in one or two locations and to the wheel structure (knuckle) in one location. The control arms may include one or more ball joints and one or more bushings at the mounting points.

### SUMMARY

A control arm for vehicular suspensions is provided. The control arm includes a first clamshell half and a second clamshell half, a ball joint housing, and a paddle portion. The paddle portion is formed as a single piece with the ball joint housing, and has a first side and a second side. The paddle portion is disposed between the first clamshell half and the second clamshell half, such that the paddle portion does not have a single-sided attachment to only one of the first clamshell half or the second clamshell half.

A first weld connection may join the first clamshell half to the first side of the paddle portion, such that the first side of the paddle portion is in contact with, and joined to, the first clamshell half. Furthermore, a second weld connection may join the second clamshell half to the second side of the paddle portion, such that the second side of the paddle portion is in contact with, and joined to, the second clamshell half. Attachment of the first clamshell half to the first side of the paddle portion and attachment of the second clamshell half to the second side of the paddle portion may be characterized by the absence of either a rivet or a bolt.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic isometric view of a stamped steel control arm;

FIG. 2 is a schematic exploded isometric view of the control arm shown in FIG. 1;

FIG. 3 is a schematic close up isometric view of the control arm shown in FIG. 1, showing a cutaway view of a ball and socket joint; and

FIG. 4 is a schematic planar cross-section view of the control arm taken along line 4-4 of FIG. 3.

### DETAILED DESCRIPTION

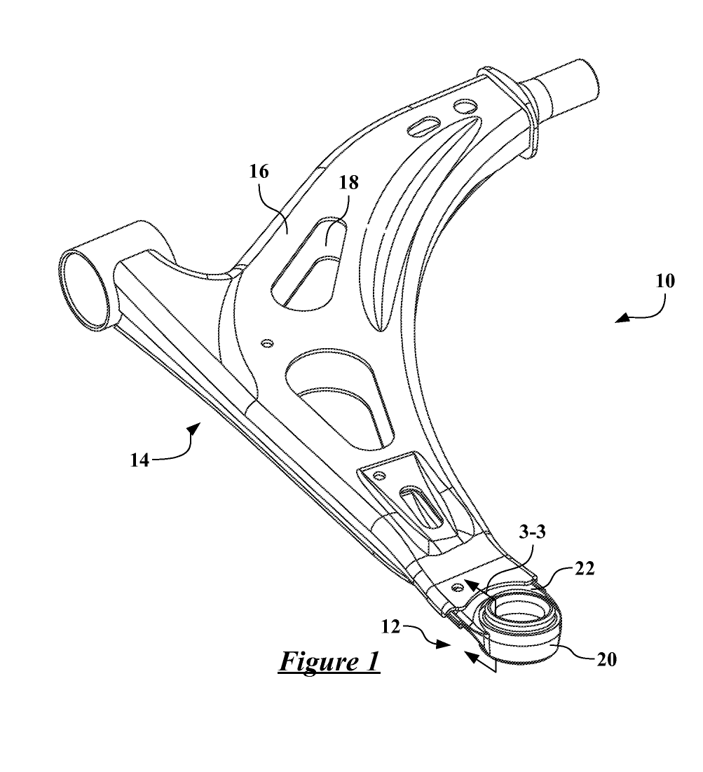

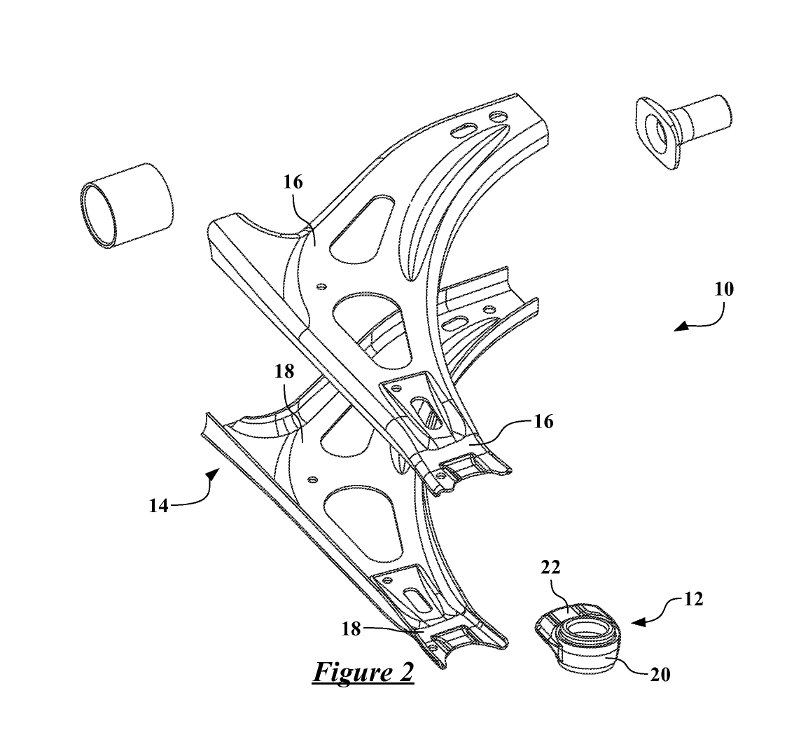

Referring to the drawings, wherein like reference numbers correspond to like or similar components throughout the several figures, there are shown in FIG. 1 and FIG. 2 two views of a control arm 10. FIG. 1 shows a schematic isometric view of the control arm 10. FIG. 2 shows an exploded isometric view of the control arm 10. The control arm 10 includes a ball and socket joint 12 and a stamped arm 14.

While the present invention is described in detail with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

The stamped arm 14 is formed from a first clamshell half 16 and a second clamshell half 18. The first clamshell half 16 and the second clamshell half 18 are assembled together to form the stamped arm 14. Each of the first clamshell half 16 and the second clamshell half 18 may be formed from steel, and each of the first clamshell half 16 and the second clamshell half 18 may be formed by stamping.

The ball and socket joint 12 attaches to the stamped arm 14 and is configured to transfer force and allow rotation between a knuckle (not shown) and another portion of the vehicle chassis (not shown). The ball and socket joint 12 includes a ball housing 20 and a paddle portion 22 formed as a single piece with the ball housing 20.

The paddle portion 22 includes a first side 24 and a second side 26 opposite the first side 24. The paddle portion 22 is disposed between the first clamshell half 16 and the second clamshell half 18. The first side 24 of the paddle portion 22 is in contact with the first clamshell half 16 of the stamped arm 14, and the second side 26 of the paddle portion 22 is in contact with the second clamshell half 18 of the stamped arm 14. Therefore, the paddle portion 22 is sandwiched inside of the stamped arm 14 and is in contact with the stamped arm 14 on both sides, as opposed to attaching to only one of the first clamshell half 16 or the second clamshell half 18.

In another configuration, the ball and socket joint 12 may include a first butterfly tab (not shown) formed as a single piece with the paddle portion 22 and a second butterfly tab (not shown) formed as a single piece with the paddle portion 22. The first butterfly tab and the second butterfly tab are disposed between the first clamshell half 16 and the second clamshell half 18, extend further into the clamshell formed by the stamped arm 14, and carry loads between the ball housing 20 and the stamped arm 14. A cutout area (not shown) may therefore also be defined between the first butterfly tab and the second butterfly tab.

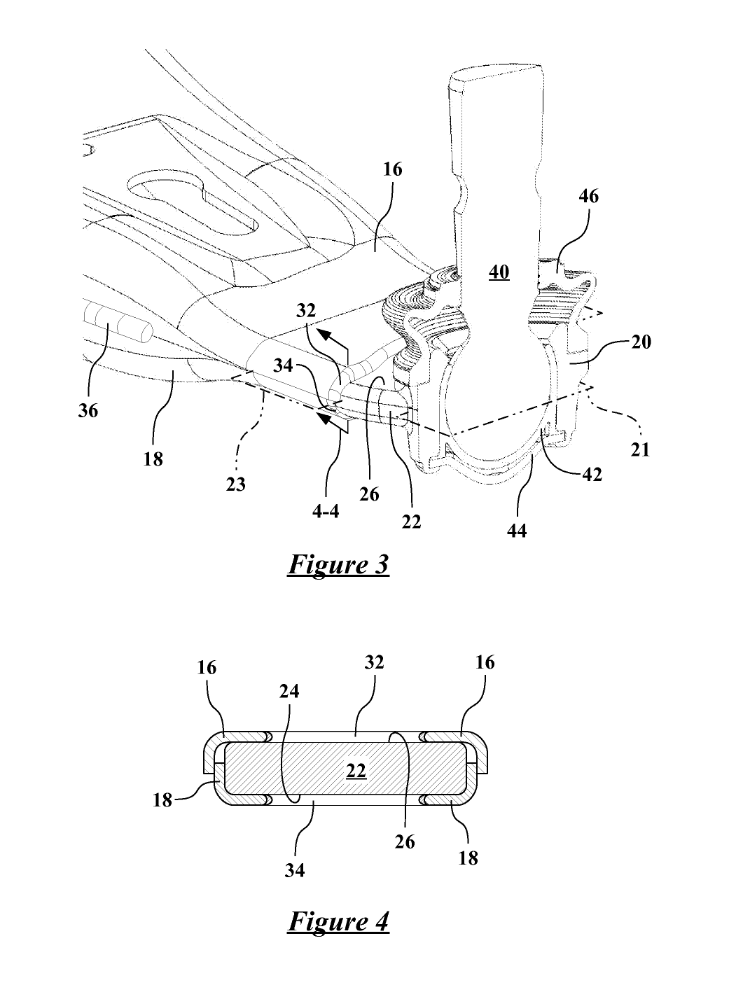

Referring now to FIG. 3, and with continued reference to FIGS. 1 and 2, there is shown a close-up view of the control arm 10 shown in FIG. 1. FIG. 3 shows the ball and socket joint 12 in more detail, and has a partial cross-sectional view through the ball and socket joint 12 along the section line 3-3 shown in FIG. 1.

As viewed in FIG. 3, and also in FIG. 1, the ball and socket joint 12 is joined to the stamped arm 14 with a first weld connection 32 and a second weld connection 34. The first weld connection 32 joins the first clamshell half 16 to the first side 24 of the paddle portion 22, and the second weld connection 34 joins the second clamshell half 18 to the second side 26 of the paddle portion 22. The stamped arm 14 also includes a third weld connection 36 joining the first clamshell half 16 to the second clamshell half 18.

As shown in the cross-sectional portion of FIG. 3, the ball and socket joint 12 includes a ball stud 40 disposed within the ball housing 20. A race 42 surrounds the portion of the ball stud 40 within the ball housing 20 and a cap 44 retains the ball stud 40 from axial movement in the ball housing 20. A seal 46 prevents the ingress of dirt, moisture, or other foreign matter into the interior of the ball and socket joint 12. The ball and socket joint 12 allows multi-axis movement of components attached to the ball stud 40 relative to the control arm 10.

The paddle portion 22 defines a paddle plane 23, which is generally parallel to the paddle portion 22; and the ball housing 20 defines a housing plane 21, which is generally parallel to the ball housing 20. The ball stud 40 is generally perpendicular to the housing plane 21. The paddle plane 23 may be substantially parallel to the housing plane 21, as shown in FIGS. 1-3. However, the housing plane 21 may also be oriented at an angle, or perpendicular, to the paddle plane 23, depending upon the configuration of the suspension system.

Referring now to FIG. 4, and with continued reference to FIGS. 1-3, there is shown a cross-sectional view of the control arm 10 taken along line 4-4 of FIG. 3. As shown in FIG. 4, the paddle portion 22 is disposed between and substantially surrounded by the first clamshell half 16 and the second clamshell half 18. As shown in FIGS. 3 and 4, in this configuration, the first clamshell half 16 is wider than the second clamshell half 18 and overlaps the second clamshell half 18 around the paddle portion 22.

The first weld connection 32 joins the first clamshell half 16 to the first side 24 of the paddle portion 22, and the second weld connection 34 joins the second clamshell half 18 to the second side 26 of the paddle portion 22. The third weld connection 36 may or may not extend all the way to the first weld connection 32 and the second weld connection 34.

In the configuration shown in FIGS. 3 and 4, the first weld connection 32 and the second weld connection 34 may join or intersect to form a substantially-continuous weld seam, which joins the first clamshell half 16 and the second clamshell half 18 to the paddle portion 22. The continuous weld seam is substantially the only fastening mechanism joining the ball and socket joint 12 to the stamped arm 14. The first clamshell half 16 is attached to the first side 24 of the paddle portion 22 and of the second clamshell half 18 is attached to the second side 26 of the paddle portion 22 without the use of a rivet, a bolt, or other mechanical fasteners.

The detailed description and the drawings or figures are supportive and descriptive of the invention, but the scope of the invention is defined solely by the claims. While the best mode, if known, and other embodiments for carrying out the claimed invention have been described in detail, various alternative designs and embodiments exist for practicing the invention defined in the appended claims.

1. A control arm, comprising:
a first clamshell half;
a second clamshell half;
a ball joint housing; and
a paddle portion formed as a single piece with the ball joint housing, and having a first side and a second side, wherein the paddle portion is disposed between the first clamshell half and the second clamshell half.

2. The control arm of claim 1, wherein the first side of the paddle portion is in contact with the first clamshell half and the second side of the paddle portion is in contact with the second clamshell half.

3. The control arm of claim 2, further comprising:
a first weld connection joining the first clamshell half to the first side of the paddle portion; and
a second weld connection joining the second clamshell half to the second side of the paddle portion.

4. The control arm of claim 3, wherein the first clamshell half and the second clamshell half are formed from steel, and the first clamshell half and the second clamshell half are formed by stamping.

5. The control arm of claim 4, wherein attachment of the first clamshell half to the first side of the paddle portion and attachment of the second clamshell half to the second side of the paddle portion is characterized by the absence of a rivet and the absence of a bolt.

6. The control arm of claim 5, wherein the paddle portion defines a paddle plane, wherein the ball joint housing defines a housing plane, and wherein the paddle plane is substantially parallel to the housing plane.

7. The control arm of claim 6, further comprising a third weld connection joining the first clamshell half to the second clamshell half.

8. The control arm of claim 7, wherein the first weld connection and the second weld connection join to form a substantially continuous weld seam joining the first clamshell half and the second clamshell half to the paddle portion.

9. A control arm, comprising:
a first clamshell half;
a second clamshell half;
a ball joint housing;
a paddle portion formed as a single piece with the ball joint housing, and having a first side and a second side, wherein the paddle portion is disposed between the first clamshell half and the second clamshell half;
a first weld connection joining the first clamshell half to the first side of the paddle portion, such that the first side of the paddle portion is in contact with the first clamshell half; and
a second weld connection joining the second clamshell half to the second side of the paddle portion, such that the second side of the paddle portion is in contact with the second clamshell half,
wherein attachment of the first clamshell half to the first side of the paddle portion and attachment of the second clamshell half to the second side of the paddle portion is characterized by the absence of a rivet and the absence of a bolt.

10. The control arm of claim 9, wherein the first weld connection and the second weld connection join to form a substantially continuous weld seam joining the first clamshell half and the second clamshell half to the paddle portion.

11. The control arm of claim 10, further comprising a third weld connection joining the first clamshell half to the second clamshell half.

12. The control arm of claim 11, wherein the paddle portion defines a paddle plane, wherein the ball joint housing defines a housing plane, and wherein the paddle plane is substantially parallel to the housing plane.

13. The control arm of claim 12, wherein the first clamshell half and the second clamshell half are formed from steel, and the first clamshell half and the second clamshell half are formed by stamping.
